(19) United States
(12) Patent Application Publication
(10) Pub. No.: US 2006/0127685 A1
(43) Pub. Date: Jun. 15, 2006

(54) Layered polyimide/metal product

(75) Inventors: Koji Hirota, Chiba (JP); Naoki Nakazawa, Chiba (JP); Youichi Kodama, Chiba (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUI CHEMICALS, INC., Tokyo (JP)

(21) Appl. No.: 10/544,185

(22) PCT Filed: Feb. 9, 2004
(86) PCT No.: PCT/JP04/01316

§ 371 Date: Aug. 1, 2005

(30) Foreign Application Priority Data
Feb. 18, 2003 (JP) 2003-039146

(51) Int. Cl. B32B 15/08

(52) U.S. Cl. 428/458; 428/473.5

(57) ABSTRACT

A polyimide metal laminate comprising a polyimide resin formed on a metal foil, wherein the polyimide resin does not cause the peeling of not less than 100 μm in the polyimide resin and/or at an interface between the polyimide resin and the metal foil when the polyimide resin is heated in an oven at an atmospheric temperature of from 340 to 360° C. for 5 to 10 minutes, the coefficient of humidity expansion at 320 is from 1 to 20 ppm/% RH, and an average value of the etching rate by a 50 wt % aqueous solution of potassium hydroxide at 80° C. is not less than 1.0 μm/min. The polyimide metal laminate can provide good heat resistance, superior dimensional stability and can be etching processed by an aqueous alkaline solution.

### TECHNICAL FIELD

The present invention relates to polyimide metal laminates widely used for flexible wiring substrates, wireless suspensions of hard disk drives or the like.

More specifically, the invention relates to a polyimide metal laminate which is suitable for a high density circuit substrate material capable of part assembly at a high temperature and ultra fine processing since heat resistance of polyimide is good, the dimensional stability in relative to humidity is superior and the wet etching property is excellent.

### BACKGROUND ART

At present, with high density and high speed of a hard disk drive, a so-called wireless suspension mainly with copper wiring directly formed thereon has been used for a suspension for a hard disk drive. As a material of this wireless suspension, a polyimide metal laminate comprising a copper alloy/polyimide/SUS304 has been widely used.

As a method for producing a wireless suspension using this polyimide metal laminate, for example, there has been proposed a production method comprising carrying out a predetermined pattern on the copper alloy layer and the SUS304 layer, and then removing the polyimide layer by plasma etching for processing the suspension (refer to JP1997-293222A and the like). This method using the plasma etching has an advantage capable of having the degree of freedom in the design of a suspension because it is easy to conduct the polyimide etching having a fine shape and it is easy to form a flying lead. However, the plasma etching has drawbacks such that the productivity in this case is very bad, the plasma etching device is high-priced and the process cost is high since the etching rate of polyimide is very slow as compared to the etching rate of a metal or the like and the plasma etching is a single-wafer etching.

In order to overcome such problems, as a method for etching the polyimide layer, there has been proposed a wet etching which can be applied by using a polyimide layer capable of carrying out the wet etching by an aqueous alkaline solution instead of the plasma etching (refer to JP2002-240193A and the like). In the above patent has been proposed a polyimide metal laminate plate capable of the wet etching by using a polyimide layer which is capable of the wet etching by an aqueous alkaline solution and excellent in adhesion with a metal foil. However, with attention paid to heat resistance of the polyimide resin itself but with no attention paid to heat resistance at an interface between the polyimide resin and the metal foil, and at the periphery of the interface, when the polyimide metal laminate plate described in the above patent was exposed to a high temperature of not less than 300° C. during processing, there has been a problem in that peeling at the interface between the polyimide resin and the metal foil, and at the periphery of the interface easily occurred. Furthermore, there is a characteristic in that the coefficient of thermal expansion of the polyimide resin is almost in the same range of the coefficient of thermal expansion of the metal foil so that the dimensional stability by a heat treatment is superior. However, no attention has been paid to the dimensional stability in relative to the change in humidity, when the polyimide metal laminate plate is processed by the wet etching, there has been pointed out a problem of warpage in the processing shape influenced by the change in humidity.

### DISCLOSURE OF THE INVENTION

Under these circumstances, an object of the present invention is to provide a polyimide metal laminate which is excellent in the dimensional stability in relative to the change in a temperature and the change in humidity to be exposed when processing the polyimide metal laminate, which is capable of ultra fine processing, and which is excellent in heat resistance. Furthermore, the present invention is to provide a polyimide metal laminate capable of the wet etching by an aqueous alkali solution.

The present inventors have conducted an extensive study and as a result, have found that, in a polyimide metal laminate comprising a copper foil and a stainless steel foil formed on both sides of a polyimide resin or stainless steel foils formed on both sides thereof, the above object can be solved by using the polyimide resin in which heat resistance is not less than 350° C. at an interface between the polyimide and the stainless steel foil or the copper foil and at the periphery of the interface, the coefficient of humidity expansion at 32° C. is from 1 to 20 ppm/% RH, the peel strength after heating at 350° C. for 60 minutes is not less than 1.0 kN/m and which is capable of the wet etching by an aqueous alkaline solution, and the polyimide metal laminate capable of the wet etching can be obtained. Thus, the present invention has been completed.

That is, the present invention relates to a polyimide metal laminate comprising a copper foil and a stainless steel foil or stainless steel foils formed on both sides of a polyimide resin, wherein the polyimide resin which comes in contact with the stainless steel foil or the cooper foil has a heat resistance temperature being not less than 350° C., the coefficient of humidity expansion at 32° C. being from 1 to 20 ppm/% RH, an average value of the etching rate by a 50 wt % aqueous solution of potassium hydroxide at 80° C. being not less than 1.0 μm/min, and the peel strength after heating at 350° C. for 60 minutes being not less than 1.0 kN/m.

According to the present invention, by improving heat resistance at an interface between the polyimide and the metal foil, and at the periphery of the interface and suppressing expansion and contraction in relative to the change in humidity of polyimide to the utmost, it is possible to provide the polyimide metal laminate which is superior in the dimensional stability in relative to the change in a temperature and the change in humidity to be exposed when processing the polyimide metal laminate. Accordingly, by using the laminate of the present invention, it is possible to cope with part mounting at a high temperature and ultra fine processing can be achieved. Further, the polyimide metal laminate in which the etching rate is fast by an alkaline solution can be obtained so that the productivity in etching can be enhanced. Thus, in particular, the polyimide metal laminate can be properly used as a material of a suspension for a hard disk drive.

### BEST MODE FOR CARRYING OUT THE INVENTION

The present invention will be described in more detail below.

The polyimide metal laminate of the present invention is provided with a copper foil and a stainless steel foil formed on both sides of the polyimide resin or stainless steel foils on both sides thereof. Specifically, it has a structure of SUS/a polyimide resin/a copper foil or SUS/a polyimide resin/SUS. As the polyimide resin layer, there can be exemplified, for example, polyimide, polyamide-imide and the like. Polyimide is preferable. The polyimide resin layer made of a single layer or multi layers belongs to the present invention. A multi-layered polyimide resin layer comprising all layers made of polyimide resins is preferable. The polyimide resin layer preferably has 2 or 3 layers from the viewpoints of simple production and easy control of properties.

The heat resistance temperature of not less than 350° C. mentioned in the present invention refers to a temperature which does not cause peeling of not less than 100 μm in the polyimide resin and/or at the interface between the polyimide resin and the stainless steel foil and/or the copper foil while heating in an oven at an atmospheric temperature of from 340 to 360° C. for 5 to 10 minutes.

The coefficient of humidity expansion mentioned in the present invention refers to a calculated value of the average value of the expansion rates by measuring the expansion rates of the polyimide resin at an air atmospheric temperature of 32° C. using a thermomechanical analyzer (TMA) manufactured by Nihon Bruker AXS K.K. when the relative humidity of the atmosphere was changed to 20%, 40%, 60% and 80%.

The peel strength after heating at 350° C. for 60 minutes mentioned in the present invention refers to a value obtained by carrying out an etching processing for the copper foil and the stainless steel foil in a line shape having a predetermined width, for example, 1.00 mm width, preparing a test specimen for the peel strength, subsequently heating the test specimen in the oven at an atmospheric temperature of from 340 to 360° C. for 60 minutes, and then peeling the copper foil and the stainless steel foil from the polyimide resin to measure the peel strength.

In the polyimide metal laminate of the present invention, the heat resistance temperature of the polyimide resin layer formed between the copper foil and the stainless steel foil or between stainless steel foils needs not to cause the peeling of not less than 100 μm in the polyimide resin and/or at the interface between the polyimide resin and the metal foil when heating the polyimide metal laminate for 5 to 10 minutes in the oven at an atmospheric temperature of from 340 to 360° C. and preferably near 350° C. The polyimide metal laminate of the present invention is processed into a flexible wiring board or a suspension and is exposed to the heating atmosphere of about 350° C. when assembling chips or sliders on the polyimide metal laminate. This is because, at that time, it is required that the peeling does not occur.

The atmosphere in the oven is air. The atmospheric temperature refers to a temperature in which the temperature of the polyimide metal laminate becomes from 340 to 360° C. and preferably 350° C., whereas the temperature of the whole oven is not required to be from 340 to 360° C. and preferably 350° C. The polyimide metal laminate needs to be heated for about 5 to 10 minutes in the oven, but preferably at least for 10 minutes. This is because heat resistance for a long time is required. During heating and/or after heating in the oven, it is required that peeling of not less than 100 μm does not occur, but when the peeling occurs at this time, it is required that the peeling does not occur in any of the polyimide resin, and the interface between the polyimide resin and the metal foil. When the size of the peeling is less than 100 μm, there is no problem in appearance. The size is preferably less than 50 μm and more preferably less than 0.1 μm.

Furthermore, in the polyimide metal laminate of the present invention, the polyimide resin layer formed between the copper foil and the stainless steel foil or between the stainless steel foils is required to have the coefficient of humidity expansion at 32° C. of from 1 to 20 ppm/% RH from the viewpoint of the dimensional stability of the polyimide metal laminate in relative to humidity. The coefficient of humidity expansion is preferably small since the dimensional stability in relative to humidity is superior. The coefficient of humidity expansion is preferably from 1 to 15 ppm/% RH and more preferably from 1 to 10 ppm/% RH. The coefficient of humidity expansion of polyimide can be generally reduced by lowering the water absorption rate of polyimide and reducing the coefficient of thermal expansion. Namely, the water absorption rate can be lowered by reducing the concentration of an imide group contained in a polymer chain of polyimide, while the coefficient of thermal expansion can be reduced by making the polyimide chain to a rigid structure.

Furthermore, in the polyimide metal laminate of the present invention, the polyimide resin formed between the copper foil and the stainless steel foil or between stainless steel foils needs to have the average value of the etching rate by a 50 wt % aqueous solution of potassium hydroxide at 80° C. being not less than 1.0 μm/min. The average value is more preferably not less than 1.5 μm/min. As the etching rate is greater, it is preferable that the processing shape of the polyimide resin becomes better. However, the etching rate of less than 5.0 μm/min is preferable because it is easy to control the processing shape. When the polyimide resin is formed of polyimide resins with two or more layers, the average value of the etching rates of polyimide resins for all layers in use may be not less than 1.0 μm/min and the value of the etching rates for the respective layers to be constituted is not restricted. The average value of the etching rates mentioned herein refers to a value obtained by dividing the thickness of the polyimide resin by the time required for removing all polyimide resins by etching. When the average value is not less than 1.0 μm/min, the productivity at the time of etching is good. The etching rate is changed by the molecular structure of the polyimide resin. Accordingly, since the etching rate is changed depending on the structure of a diamine and an acid dianhydride in use for the polyimide resin, the type and amount of the diamine and the acid dianhydride which can be used are restricted.

When the polyimide resin of the polyimide metal laminate of the present invention is actually subjected to an etching processing, the etching solution may be an aqueous alkaline solution and is not restricted to the above 50 wt % aqueous solution of potassium hydroxide at 80° C. As the etching solution, potassium hydroxide, sodium hydroxide, lithium hydroxide and the like can be used. In order to improve affinity with polyimide for the aqueous alkaline solution to promote etching, ethanol amine, propanol amine, butanol amine, diethanol amine, dipropanol amine, hydrazine monohydrate, ethylene diamine, dimethyl amine and the like may be preferably contained in the etching solution. As the content, they can be mixed in a ratio of from 5 to 80% and preferably in a ratio of from 30 to 50%.

The polyimide metal laminate of the present invention needs to have the peel strength of the polyimide resin layer after heating at 350° C. for 60 minutes being not less than 1.0 kN/m. The peel strength after heating at 350° C. for 60 minutes refers to a value obtained by carrying out an etching processing for the copper foil and the stainless steel foil in a line shape having a predetermined width, for example, 1.00 mm width, preparing a test specimen for the peel strength, subsequently heating the test specimen in the oven at an atmospheric temperature of from 340 to 360° C. for 60 minutes, and then peeling the copper foil and the stainless steel foil from the polyimide resin to measure the peel strength. The peel strength is more preferably in the range of 1.0 to 3.0 kN/m. Within this range, fine processing is properly realized without peeling, deformation and the like after the metal is processed into a circuit. When the peel strength is less than 1.0 kN/m, peeling after the circuit processing occurs; therefore, such a peel strength is not preferable. When it is greater than 3.0 kN/m, internal peeling of the resin occurs in some cases. At that time, it cannot be said to be meant by the peel strength of the polyimide resin layer and the metal any longer.

In the polyimide metal laminate of the present invention, the polyimide resin which comes in contact with the stainless steel foil or the copper foil is preferably a thermoplastic polyimide obtained by reacting a diamine with a tetracarboxylic acid dianhydride, wherein the tetracarboxylic acid dianhydride in use is at least one kind of tetracarboxylic acid dianhydride selected from 3,3′,4,4′-benzophenone tetracarboxylic acid dianhydride, pyromellitic acid dianhydride, p-(phenylene bis(trimellitic monoester anhydride)), 3,3′4,4′-ethylene glycol dibenzoate tetracarboxylic acid dianhydride and 2,2-bis(4-hydroxyphenyl)propane-3,3′,4,4′-benzophenone tetracarboxylic acid dianhydride, and 3,3′,4,4′-benzophenone tetracarboxylic acid dianhydride is preferably not less than 5 mole % and not more than 50 mole % of the tetracarboxylic acid dianhydride in use and more preferably in the range of not less than 10 mole % and not more than 40 mole %. By using 3,3′,4,4′-benzophenone tetracarboxylic acid dianhydride in the above range, it is possible to achieve a desirable effect of increasing the heat resistance temperature of the polyimide metal laminate without reducing the etching rate due to an aqueous solution of potassium hydroxide.

Furthermore, in the polyimide metal laminate of the present invention, the polyimide resin which comes in contact with the stainless steel foil or the copper foil is preferably a thermoplastic polyimide obtained by reacting a diamine with a tetracarboxylic acid dianhydride, wherein pyromellitic acid dianhydride is preferably not less than 50 mole % of the whole tetracarboxylic acid dianhydride in use and more preferably in the range of not less than 60 mole % and not more than 90 mole %. By using pyromellitic acid dianhydride in the above range, it is possible to achieve a desirable effect of increasing the etching rate due to an aqueous solution of potassium hydroxide.

Namely, in the polyimide metal laminate of the present invention, the polyimide resin which comes in contact with the stainless steel foil or the copper foil is preferably a thermoplastic polyimide obtained by reacting a diamine with a tetracarboxylic acid dianhydride, wherein the tetracarboxylic acid dianhydride in use is more preferably not less than 50% of the pyromellitic acid dianhydride (hereinafter referred to as PMDA in some cases) and from 5 to 50% (not exceeding 100% in total) of 3,3′,4,4′-benzophenone tetracarboxylic acid dianhydride (hereinafter referred to as BTDA in some cases), and more preferably from 10 to 40% of BTDA and from 60 to 90% of PMDA (not exceeding 100% in total).

In the polyimide metal laminate of the present invention, the polyimide resin which comes in contact with the stainless steel foil or the copper foil is further preferably a thermoplastic polyimide obtained by reacting a diamine with a tetracarboxylic acid dianhydride, wherein the polyimide resin contains at least one kind of diamine selected from 1,3-bis(3-aminophenoxy)benzene, 4,4′-bis(3-aminophenoxy)biphenyl, 3,3′-diaminobenzophenone and 1,3-bis(3-(3-aminophenoxy)phenoxy)benzene, and preferably contains 1,3-bis(3-aminophenoxy)benzene and 1,3-bis(3-(3-aminophenoxy)phenoxy)benzene as the diamine in use. Further, any arbitrary diamine can also be added in the ranges in which the properties of the thermoplastic polyimide are not damaged. When these diamines are mixed with an arbitrary diamine other than those described above, these specific diamines are preferably mixed therewith in the amount of not less than 70 mole % and more preferably in the amount of not less than 80 mole %.

Concrete examples of the arbitrary diamine are not particularly restricted and include m-phenylenediamine, o-phenylenediamine, p-phenylenediamine, m-aminobenzylamine, p-aminobenzylamine, bis(3-aminophenyl)sulfide, (3-aminophenyl)(4-aminophenyl)sulfide, bis(4-aminophenyl)sulfide, bis(3-aminophenyl)sulfoxide, (3-aminophenyl)(4-aminophenyl)sulfoxide, bis(3-aminophenyl)sulfone, (3-aminophenyl)(4-aminophenyl)sulfone, bis(4-aminophenyl)sulfone, 3,3′-diaminobenzophenone, 3,4′-diaminobenzophenone, 4,4′-diaminobenzophenone, 3,3′-diaminodiphenylmethane, 3,4′-diaminodiphenylmethane, 4,4′-diaminodiphenylmethane, 4,4′-diaminodiphenylether, 3,3′-diaminodiphenylether, 3,4′-diaminodiphenylether, bis[4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis(3-aminophenoxy)benzene, 1,4-bis(3-aminophenoxy)benzene, 1,4′-bis(4-aminophenoxy)benzene, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfoxide, bis[4-(aminophenoxy)phenyl]sulfoxide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 1,4-bis[4-(3-aminophenoxy)benzoyl]benzene, 1,3-bis[4-(3-aminophenoxy)benzoyl]benzene, 4,4′-bis[3-(4-aminophenoxy)benzoyl]diphenylether, 4,4′-bis[3-(3-aminophenoxy)benzoyl]diphenylether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, bis[4-{4-(4-aminophenoxy)phenoxy}phenyl]sulfone, 1,4-bis[4-(4-aminophenoxy)-α,α-dimethylbenzyl]benzene, 1,3-bis[4-(4-aminophenoxy)-α,α-dimethylbenzyl]benzene, 1,3-bis(3-(4-aminophenoxy)phenoxy)benzene, 1,3-bis(3-(2-aminophenoxy)phenoxy)benzene, 1,3-bis(4-(2-aminophenoxy)phenoxy)benzene, 1,3-bis(2-(2-aminophenoxy)phenoxy)benzene, 1,3-bis(2-(3-aminophenoxy)phenoxy)benzene, 1,3-bis(2-(4-aminophenoxy)phenoxy)benzene, 1,4-bis(3-(3-aminophenoxy)phenoxy)benzene, 1,4-bis(3-(4-aminophenoxy)phenoxy)benzene, 1,4-bis(3-(2-aminophenoxy)phenoxy)benzene, 1,4-bis(4-(2-aminophenoxy)phenoxy)benzene, 1,4-bis(2-(2-aminophenoxy)phenoxy)benzene, 1,4-bis(2-(3-aminophenoxy)phenoxy)benzene, 1,4-bis(2-(4-aminophenoxy)phenoxy)benzene, 1,2-bis(3-(3-aminophenoxy)phenoxy)benzene, 1,2-bis(3-(4-aminophenoxy)phenoxy)benzene, 1,2-bis(3-(2-aminophenoxy)phenoxy)benzene, 1,2-bis(4-(4-aminophenoxy)phenoxy)benzene, 1,2-bis(4-(3-aminophenoxy)phenoxy)benzene, 1,2-bis(4-(2-aminophenoxy)phenoxy)benzene, 1,2-bis(2-(2-aminophenoxy)phenoxy)benzene, 1,2-bis(2-(3-aminophenoxy)phenoxy)benzene, 1,2-bis(2-(4-aminophenoxy)phenoxy)benzene, 1,3-bis(3-(3-aminophenoxy)phenoxy)-2-methylbenzene, 1,3-bis(3-(4-aminophenoxy)phenoxy)-4-methylbenzene, 1,3-bis(4-(3-aminophenoxy)phenoxy)-2-ethylbenzene, 1,3-bis(3-(2-aminophenoxy)phenoxy)-5-sec-butylbenzene, 1,3-bis(4-(3-aminophenoxy)phenoxy)-2,5-dimethylbenzene, 1,3-bis(4-(2-amino-6-methylphenoxy)phenoxy)benzene, 1,3-bis(2-(2-amino-6-ethylphenoxy)phenoxy)benzene, 1,3-bis(2-(3-aminophenoxy)-4-methylphenoxy)benzene, 1,3-bis(2-(4-aminophenoxy)-4-tert-butylphenoxy)benzene, 1,4-bis(3-(3-aminophenoxy)phenoxy)-2,5-di-tert-butylbenzene, 1,4-bis(3-(4-aminophenoxy)phenoxy)-2,3-dimethylbenzene, 1,4-bis(3-(2-amino-3-propylphenoxy)phenoxy)benzene, 1,2-bis(3-(3-aminophenoxy)phenoxy)-4-methylbenzene, 1,2-bis(3-(4-aminophenoxy)phenoxy)-3-n-butylbenzene, 1,2-bis(3-(2-amino-3-propylphenoxy)phenoxy)benzenebis(3-aminopropyl)tetramethydisiloxane, bis(10-aminodecamethylene)tetramethyldisiloxane, bis(3-aminophenoxymethyl)tetramethyldisiloxane and the like. These diamines can be mixed in a ratio of less than 30 mole % and preferably less than 20 mole %.

When producing the aforementioned thermoplastic polyimide, the reactive molar ratio of the diamine component and tetracarboxylic acid dianhydride is preferably in the range of 0.75 to 1.25 since it is easy to control the reaction and the heat fluidity of the thermoplastic polyimide to be synthesized is good. The molar ratio is more preferably from 0.90 to 1.10.

As a method for producing the polyimide metal laminate of the present invention, a method for heat-pressing the polyimide resin, and the copper foil and the stainless steel foil to put the polyimide resin therebetween or a method comprising coating the copper foil or the stainless steel foil with a precursor varnish of polyimide and then drying, and further heat-pressing the copper foil or the stainless steel foil can be cited, but the method is not particularly restricted thereto.

Furthermore, the polyimide metal laminate of the present invention can be processed into a suspension for a hard disk drive by carrying out an etching processing of the metal foil and a wet etching of polyimide, and is used as such.

The polyimide metal laminate of the present invention is composed of the copper foil or the stainless steel foil formed on both sides of the polyimide resin layer. The metal foil is not particularly restricted. The copper foil mentioned in the present invention also comprises a copper alloy foil. The copper foil may preferably have the spring characteristic. Desirable examples of commercial products include C7025 foil manufactured Olin Corporation, B52 foil manufactured by Olin Corporation, NK120 foil manufactured by Nikko Materials Co., Ltd, EFTE64-T manufactured by Furukawa Electric Co., Ltd., USLP foil manufactured by Nippon Denkai, Ltd. and the like. The stainless steel foil is not particularly restricted either, but may preferably have the spring characteristic. Preferred examples thereof concretely include SUS304H-TA foil manufactured by Nippon Steel Corporation, SUS304H-TA foil manufactured by Toyo Seihaku Co., Ltd. and the like. Incidentally, the spring characteristic refers to a characteristic of elastic behavior owned by metals or rubbers and a characteristic having sufficient strength for restoring to the original shape when deformed. When the polyimide metal laminate of the present invention is used as a suspension for a hard disk drive, the spring characteristic is needed.

In the present invention, by thinning the metal foil, miniaturization and light-weightness of electrical appliances using the polyimide metal laminate can be preferably sought. The thickness of the copper foil and/or the stainless steel foil is preferable from 2 to 150 μm and more preferably from 2 to 100 μm.

The thickness of the thermoplastic polyimide is preferably from 0.5 to 50 μm and more preferably from 1 to 25 μm from the fact that miniaturization and light-weightness of electrical appliances using the polyimide metal laminate can be sought by thinning, as in the metal foil.

In the polyimide metal laminate of the present invention, the polyimide resin layer is preferably multi-layered and more preferably in a three-layered structure comprising a thermoplastic polyimide layer/a non-thermoplastic polyimide layer/a thermoplastic polyimide layer. The preferred thermoplastic polyimide which directly comes in contact with the stainless steel foil and the copper foil is described above. The polyimide resin layer forming other layers is not particularly restricted, but commercial non-thermoplastic polyimide films can be used. Product names: APICAL NPI and APICAL HP (registered trademark) manufactured by Kaneka Corporation, product name: KAPTON EN (registered trademark) manufactured by Du Pont-Toray. Co., Ltd. and the like can be preferably used. Further, as the polyimide resin layer which can be laminated to the thermoplastic polyimide which directly comes in contact with the stainless steel foil and the copper foil, an arbitrary polyimide obtained by reacting a known diamine with a tetracarboxylic acid dianhydride can also be used in the ranges in which the properties of the polyimide metal laminate are not damaged, in addition to the above commercial non-thermoplastic polyimide films. The properties of the whole polyimide resin layer are not particularly restricted as far as they have the aforementioned properties.

In the polyimide metal laminate of the present invention, when the polyimide resin layer has a structure of a thermoplastic polyimide layer/a non-thermoplastic polyimide layer/a thermoplastic polyimide layer, as the preferred non-thermoplastic polyimide, there can be mentioned, for example, a blend of at least one kind of diamine selected from 4,4′-bis(3-aminopheonxy)biphenyl and 3,3′-diaminobiphenylether, 1,3-bis(3-aminophenoxy)benzene; a non-thermoplastic polyimide A obtained by synthesizing from at least one kind of tetracarboxylic acid dianhydride selected from pyromellitic acid dianhydride and 3,3′,4,4′-diphenylether tetracarboxylic acid dianhydride; and a non-thermoplastic polyimide B obtained by synthesizing at least one kind of tetracarboxylic acid dianhydride selected from p-phenylene diamine as a diamine, 3,3′,4,4′-diphenylether tetracarboxylic acid dianhydride and pyromellitic acid dianhydride. Moreover, blends with the blending ratio of A to B (A:B) being from 6 to 25: from 94 to 75 can be used.

In the polyimide metal laminate of the present invention, when the polyimide resin layer has a structure of a thermoplastic polyimide layer/a non-thermoplastic polyimide layer/a thermoplastic polyimide layer, even the aforementioned thermoplastic polyimide can be used for the thermoplastic polyimide at the other side with no problem. Other preferred thermoplastic polyimides preferably contain at least one kind of tetracarboxylic acid dianhydride selected from pyromellitic acid anhydride and 3,3′,4,4′-benzopheone tetracarboxylic acid dianhydride as the tetracarboxylic acid dianhydride in use and at least one kind of diamine selected from 1,3-bis(3-aminophenoxy)benzene, 4,4′-bis(3-aminophenoxy)biphenyl, 3,3′-diaminobenzophenone and 1,3-bis(3-(3-aminophoexy)phenoxy)benzene as the diamine in use. More preferred examples include thermoplastic polyimide comprising 3,3′,4,4′-benzopheone tetracarboxylic acid dianhydride, 3,3′-diaminobenzophenone and the like.

When the polyimide resin is multi-layered, the thickness of the thermoplastic polyimide which comes in contact with the copper foil and the stainless steel foil is preferably from 0.5 to 3 μm and more preferably from 0.5 to 2 μm. The thickness of the non-thermoplastic polyimide which comes in contact with the thermoplastic polyimide is preferably from 5 to 16 μm and more preferably from 6 to 9 μm. The thickness of the above whole polyimide resin is preferably from 12.5 to 75 μm and more preferably from 12.5 to 18 μm from the fact that miniaturization and light-weightness of electrical appliances using the polyimide metal laminate can be sought by thinning, as in the metal foil.

The aforementioned polyimide resin can be generally obtained by a known method comprising mixing the above tetracarboxylic acid dianhydride with the diamine in a predetermined ratio to react the resulting mixture in a solvent such as N-methylpyrrolidone (NMP), methylformamide (DMF), dimethylacetamide (DMAc), dimethyl sulfoxide (DMSO), dimethyl sulfate, sulfolane, butyrolactone, cresol, phenol, halogenated phenol, cyclohexane, dioxane, tetrahydrofuran, diglyme, triglyme and the like, thereby obtaining a precursor solution of the polyimide resin by reacting at a reaction temperature in the range of 0 to 100° C., and further subjecting the precursor solution to a heat treatment at a high temperature atmosphere of from 200 to 500° C. to effect imidization, and the like.

The polyimide metal laminate of the present invention can be produced, for example, by heat-pressing the polyimide resin, and the stainless steel foil and the copper foil. A method for heat-pressing the polyimide resin and the metal foil is described below. A method for heat-pressing is not restricted. As a representative method, there can be mentioned, for example, a heat-pressing method and/or a thermo-laminating method and the like. As the heat-pressing method, the polyimide metal laminate can be produced, for example, by a method comprising cutting the polyimide resin and the metal foil in a predetermined size of a pressing machine and heat-pressing by a heat press without folding each other. The heating temperature is preferably in the temperature range of 150 to 600° C. The effective pressure is not restricted, but it is preferably from 0.01 to 50 MPa for producing the laminate. The time required for pressurizing is not particularly restricted.

The thermo-laminating method is not particularly restricted, but a method for carrying out lamination by putting between rolls is preferable. As a roll, a metal roll, a rubber roll and the like can be used. The quality of the material is not restricted, but as the metal roll, steel, stainless material or the like is used. A roll which is chrome-plated on its surface is preferably used. As the rubber roll, heat resistant silicon rubber or fluorine type rubber is preferably used on the surface of the metal roll. The laminating temperature is preferably in the temperature range of 100 to 300° C. As a heating method, a radiation heating method such as far infrared or the like, an induction heating method and the like can also be used, in addition to a conduction heating method. After the thermal lamination, a heat annealing is also preferably used. As the heating device, a usual heating furnace, autoclave and the like can be used. As the heating atmosphere, air, inert gas (nitrogen and argon) and the like can be used. As the heating method, any of a method for continuously heating a film and a method for allowing to stand at a heating furnace in a state that a coil is wound on a film is also preferable. As the heating method, a conduction heating method, a radiation heating method, a method of using the above methods together and the like are preferable. The heating temperature is preferably in the temperature range of 200 to 600° C. The heating time is preferably in the time range of 0.05 to 5,000 minutes.

Meanwhile, the polyimide metal laminate of the present invention can be produced by coating the metal foil with the precursor varnish of the polyimide resin and then drying. It can be produced by directly coating the surface of the metal foil with a solution of a thermoplastic polyimide or a polyamic acid solution of the precursor of the thermoplastic polyimide (hereinafter referred to as a varnish in a generic term) and drying. The varnish is a solution obtained by polymerizing the aforementioned specific diamine and the tetracarboxylic acid dianhydride in a solvent.

As a method for directly coating the surface of the metal foil, known methods such as a die coater, a comma coater, a roll coater, a gravure coater, a curtain coater, a spray coater and the like can be used. The coating thickness can be properly used according to the viscosity of the varnish and the like.

As a method for drying and curing the coated varnish, a usual heating and drying oven can be used. As the atmosphere of the drying oven, air, inert gas (nitrogen and argon) and the like can be used. A temperature for drying is properly selected according to the boiling point of a solvent, but the temperature range of 60 to 600° C. is properly used. The time required for drying is properly selected according to the thickness, concentration and the type of a solvent, but it is preferably from about 0.05 to 500 minutes.

In the polyimide metal laminate of the present invention, after the metal layer is processed into a circuit, the circuit is cover-coated by the polyimide resin. The polyimide resin used for cover coating needs a high temperature cure for not less than 60 minutes under an environment of 350° C. Even after the high temperature cure, it is preferable that the peel strength of the polyimide metal laminate is sufficiently high. The peel strength is more preferably not less than 1.0 kN/m.

According to the present invention, the polyimide metal laminate superior in heat resistance, the dimensional stability in relative to humidity and the polyimide etching property can be obtained. For this reason, the polyimide metal laminate of the present invention is particularly properly used as a suspension for a hard disk. As a method for preparing the suspension for a hard disk, the following method can be generally used.

Firstly, the metal surface of the metal laminate of the present invention forming a circuit is coated with a photosensitive resin or laminated. A mask in which a desired pattern image is drawn is adhered thereto for irradiating with an electromagnetic wave in a wavelength in which the photosensitive resin has sensitivity. The unexposed part is eluted using a desired developing solution to form a desired circuit image on the metal. The resulting material in such a state is immersed in a solution capable of dissolving a metal such as an iron (II) chloride and the like or dissolving the metal to be exposed by spraying the solution on the substrate. Then, the photosensitive resin is peeled off using a desired peeling solution to obtain a circuit.

Next, a mask in which a desired pattern image is drawn in the same manner is adhered on the circuit formed on the metal surface for patterning an insulating resin layer using a wet etching process. After carrying out patterning, a suspension can be produced by joining a stainless-processed product that is called a load beam therewith by laser welding and the like. Incidentally, a method for producing the suspension for a hard disk drive of the present invention is not restricted to the aforementioned methods and it does not matter if other methods are used for the production.

### EXAMPLES

The present invention is now more specifically illustrated below with reference to Examples and Comparative Examples. Incidentally, various properties in Examples are evaluated by the methods described below.

[Evaluation of Heat Resistance]

The prepared polyimide metal laminate was fed into an inert oven at an atmospheric temperature set to 350° C. and allowed to stand for 10 minutes. Since then, the polyimide metal laminate was taken out of the inert oven and cooled down to a room temperature. Then, it was confirmed whether peeling occurred or not from the surface of polyimide resin using a stereo microscope of 100 magnifications. Further, when peeling was detected, the size of peeling was measured. When the size was not less than 100 μm, the laminate was determined as unacceptable. When there was detected peeling but not in the size of not less than 100 μm, heat resistance was determined to be not less than 350° C. so that the laminate was determined as acceptable.

[Measurement of the Coefficient of Humidity Expansion]

Stainless and a copper foil were removed by etching using an iron (II) chloride solution heated at 40° C. from the prepared polyimide metal laminate. Vapor gas generated from a dew point control gas generating device (a product of Nihon Bruker AXS K.K.) was introduced using a thermomechanical analyzer (a product of Nihon Bruker AXS K.K.) and maintained at a temperature of 32° C. By changing the relative humidity to 20%, 40%, 60% and 80%, the expansion rates at each relative humidity were measured to obtain the coefficient of humidity expansion as an average.

[Measurement of the Average Etching Rate]

A polyimide resin was formed on a metal foil, a thickness of the polyimide resin was measured, then the polyimide resin with the metal foil remained thereon was immersed in a 50% aqueous solution of potassium hydroxide at 80° C. until the polyimide resin disappeared completely, and the time for disappearance of the resin was measured. The value obtained by dividing the initial thickness of the polyimide resin by the time for disappearance of all the polyimide resin was taken for the rate of etching as an average.

[Measurement of the Peel Strength after Heating]

A peel test specimen was cut down in a size of 25 mm for a short edge×50 mm for a long edge, the peel test specimen with a 3.2 mm wide metal part left on its center was allowed to stand for 60 minutes in an oven at an atmospheric temperature of from 340 to 350° C., and then the specimen was taken out of the oven. After the temperature of the peel test specimen became not more than 40° C., the peel strength after heating was measured. The peel strength was measured using STROGRAPH manufactured by Toyo Seiki Co., Ltd. under the environment of 23° C. and 50% RH. For one sample, the peel strength was measured for 5 points and an average value of 5 points was taken for the peel strength after heating.

Meanwhile, abbreviations for solvents, acid dianhydrides and diamines used for Examples and the like are described below.

DMAc: N,N′-dimethylacetamide

NMP: N-methyl-2-pyrrolidone

PPD: p-phenylene diamine

ODA: 4,4′-diaminodiphenylether

m-BP: 4,4′-bis(3-aminophenoxy)biphenyl

APB: 1,3-bis(3-aminophenoxy)benzene

APB5: 1,3-bis(3-(3-aminophenoxy)phenoxy)benzene

DABP: 3,3′-diaminobenzophenone

TMHQ: p-phenylene bis(trimellitic acid monoester anhydride)

TMEG: 3,3′,4,4′-ethylene glycol dibenzoate tetracarboxylic acid dianhydride

ESDA: 2,2-bis(4-hydroxyphenyl)propane-3,3′,4,4′-benzohpenone tetracarboxylic acid dianhydride

BTDA: 3,3′,4,4′-benzophenone tetracarboxylic acid dianhydride

PMDA: pyromellitic acid dianhydride

BPDA: 3,3′,4,4′-biphenyl tetracarboxylic acid dianhydride

### Synthesis Example 1

<Synthesis of a Thermoplastic Polyimide Precursor>

The tetracarboxylic acid dianhydride and diamine specified in Table 1 were weighed and dissolved in 630 g of DMAc under a nitrogen flow in a 1000-ml separable flask. After dissolving the resulting solution, the polymerization reaction was carried out by continuously stirring for 6 hours. Thus, thermoplastic polyimide precursor varnishes A to G were obtained.

TABLE 1

| Amount added | | | | | | | |
|---|---|---|---|---|---|---|---|
| (mole) | A | B | C | D | E | F | G |
| BTDA | 0.08 | 0.06 | 0.02 | 0.06 | 0.06 | 0.07 | 0.11 |
| PMDA | 0.16 | 0.10 | 0.10 | 0.09 | 0.12 | 0.14 | 0.11 |
| TMHQ | | 0.02 | | | | | |
| TMEG | | | 0.07 | | | | |
| ESDA | | | | 0.02 | | | |
| APB | 0.24 | 0.19 | 0.19 | 0.18 | | | 0.23 |
| APB5 | | | | | 0.18 | | |
| m-BP | | | | | | 0.21 | |

### Synthesis Example 2

<Synthesis of a Thermoplastic Polyimide Precursor>

The tetracarboxylic acid dianhydride and diamine specified in Table 2 were weighed and dissolved in 630 g of DMAc under a nitrogen flow in a 1000-ml separable flask. After dissolving the resulting solution, the polymerization reaction was carried out by continuously stirring for 6 hours. Thus, thermoplastic polyimide precursor varnishes H to K were obtained.

TABLE 2

| Amount added | | | | |
|---|---|---|---|---|
| (mole) | H | I | J | K |
| BTDA | 0.01 | | 0.15 | 0.09 |
| PMDA | 0.24 | 0.16 | 0.07 | 0.19 |
| BPDA | | 0.08 | | |
| APB | 0.25 | 0.24 | 0.23 | |
| ODA | | | | 0.29 |

### Synthesis Example 3

<Synthesis of a Non-thermoplastic Polyimide Precursor>

7.7 mole of PPD, 1.15 mole of ODA and 1.15 mole of m-BP were weighed as the diamine components. 5.4 mole of BPDA and 4.45 mole of PMDA were weighed as the tetracarboxylic acid components. These components were dissolved in a mixed solvent of DMAc and NMP for mixing. As the ratio of the solvent, DMAc was contained 23 weight %, while NMP was contained 77 weight %. The viscosity of the obtained polyamic acid varnish was 30,000 cps at 25° C. using an E-type viscometer, which was appropriate for coating.

### Example 1

<Preparation of a Polyimide Stainless Laminate>

On a commercial stainless steel foil (product name: SUS304H-TA, thickness: 20 μm, manufactured by Nippon Steel Corporation) was coated with each of polyamic acid varnishes A to G prepared in Synthesis Example 1 as a thermoplastic polyimide layer and dried to prepare 7 kinds of single-sided metal laminates. Further, a stainless steel foil of the same kind was laminated thereto, which was subjected to a thermal press to prepare polyimide stainless laminates A′ to G′. To coat with a polyamic acid varnish, a reverse roll coater was used and the thickness of the polyimide layer after coating and drying was 13 μm. Incidentally, the drying conditions were 100° C., 150° C., 200° C., 250° C. and 300° C. to carry out a heat treatment step by step for 5 minutes respectively. The thermal pressing conditions were 270° C., 50 kgf/cm² and 30 minutes.

<Evaluation of a Polyimide Metal Laminate>

Using the thus obtained polyimide stainless laminate, heat resistance and peel strength after heating were measured as described above. Furthermore, the stainless steel foil was removed by etching using an aqueous solution of iron (II) chloride and an average value of the etching rate was measured in the manner as described above. The stainless steel foil was further removed by etching using an aqueous solution of iron (II) chloride and the coefficient of humidity expansion was measured in the manner as described above. The results are shown in Table 3.

TABLE 3

| | A' | B' | C' | D' | E' | F' | G' |
|---|---|---|---|---|---|---|---|
| Heat | acceptable | acceptable | acceptable | acceptable | acceptable | acceptable | acceptable |
| Resistance | | | | | | | |
| Etching Rate | 1.3 | 1.5 | 1.6 | 1.2 | 1.3 | 1.2 | 1 |
| (μm/min) | | | | | | | |
| Coefficient of | 16 | 18 | 18 | 18 | 13 | 16 | 16 |
| Humidity | | | | | | | |
| Expansion | | | | | | | |
| (ppm/% RH) | | | | | | | |
| Peel Strength | 1.3 | 1.1 | 1.1 | 1.3 | 1.4 | 1.2 | 1 |
| after Heating | | | | | | | |
| (kN/m) | | | | | | | |

### Example 2

<Preparation of a Polyimide Metal Laminate>

On a commercial copper alloy foil (product name: C7025, thickness: 18 μm, manufactured by Olin Corporation) was coated with each of polyamic acid varnishes A to G prepared in Synthesis Example 1 as a thermoplastic polyimide layer and dried. Subsequently, it was coated with the polyamic acid varnish prepared in Synthesis Example 3 as a non-thermoplastic polyimide and dried and further coated with polyamic acid varnishes A to G prepared in Synthesis Example 1 respectively and dried. A single-sided polyimide metal laminate was obtained. A commercial stainless steel foil (product name: SUS304H-TA, thickness: 20 μm, manufactured by Nippon Steel Corporation) was further laminated thereto, which was subjected to a thermal press to prepare polyimide metal laminates A″ to G″. To coat with polyamic acid varnishes prepared in Synthetic Example 1, a reverse roll coater was used, while to coat with the polyamic acid varnish prepared in Synthesis Example 3, a die coater was used. The thicknesses of the polyimide layers after coating and drying were respectively 2 μm and 11 μm. Incidentally, the drying conditions were 100° C., 150° C., 200° C., 250° C., 300° C. and 350° C. to carry out a heat treatment step by step for 5 minutes respectively. The thermal press conditions were 270° C., 50 kgf/cm², and one and a half hour.

<Evaluation of the Polyimide Metal Laminate>

Using the thus obtained polyimide stainless laminate, heat resistance and peel strength after heating were measured as described above. Furthermore, the stainless steel foil was removed by etching using an aqueous solution of iron (II) chloride and an average value of the etching rate was measured in the manner as described above. The copper foil was further removed by etching using an aqueous solution of iron (II) chloride and the coefficient of humidity expansion was measured in the manner as described above. The results are shown in Table 4.

TABLE 4

| | A” | B” | C” | D” | E” | F” | G” |
|---|---|---|---|---|---|---|---|
| Heat | acceptable | acceptable | acceptable | acceptable | acceptable | acceptable | acceptable |
| Resistance | | | | | | | |
| Etching Rate | 1.1 | 1.3 | 1.3 | 1 | 1.1 | 1.1 | 1 |
| (μm/min) | | | | | | | |
| Coefficient of | 11 | 12 | 12 | 12 | 10 | 11 | 11 |
| Humidity | | | | | | | |
| Expansion | | | | | | | |
| (ppm/% RH) | | | | | | | |
| Peel Strength | 1.3 | 1.1 | 1.1 | 1.3 | 1.4 | 1.2 | 1 |
| after Heating | | | | | | | |
| (kN/m) | | | | | | | |

### Example 3

<Preparation of a Double-sided Adhesive Sheet>

Both sides of a commercial polyimide film (produce name: APICAL (registered trademark) 12.5 NPI, thickness: 12.5 μm, manufactured by Kaneka Corporation) were coated with polyamic acid varnishes A to G prepared in Synthesis Example 1 as non-thermoplastic polyimide layers and dried to prepare a double-sided adhesive sheet. To coat with thermoplastic polyamic acid varnishes in Synthesis Example 1, a reverse roll coater was used and the total thickness of the polyimide layer after coating and drying was 18 μm. Incidentally, the drying conditions were 100° C., 150° C., 200° C., 250° C. and 300° C. to carry out a thermal treatment step by step for 5 minutes respectively.

<Carrying Out of Thermal Press>

As metals, a copper alloy foil (product name: C7025 (special order brand), thickness: 18 μm, manufactured by Olin Corporation) and a stainless steel foil (product name: SUS304H-TA, thickness: 20 μm, manufactured by Nippon Steel Corporation) were used. A cushion material (product name: Kinyo Board F200, manufactured by Kinyosha Co., Ltd.) was put between the double-sided adhesive sheets with C7025 and SUS304H-TA foil folded therewith respectively and the resulting material was heat-pressed under conditions of 250° C. and 70 kg/cm² for 60 minutes by a heat-pressing machine to prepare polyimide metal laminates A′″ to G′″ comprising five layers of SUS304H-TA/a thermoplastic polyimide/a non-thermoplastic polyimide/a thermoplastic polyimide/C7025.

<Evaluation of the Polyimide Metal Laminate>

Using the thus obtained polyimide metal laminates A′″ to G′″, heat resistance and peel strength after heating were measured as described above. Furthermore, the stainless steel foil was removed by etching using an aqueous solution of iron (II) chloride and an average value of the etching rate was measured in the manner as described above. The stainless steel foil and the copper alloy foil were further removed by etching using an aqueous solution of iron (II) chloride and the coefficient of humidity expansion was measured in the manner as described above. The results are shown in Table 5.

TABLE 5

| | A'” | B'” | C'” | D'” | E'” | F'” | G'” |
|---|---|---|---|---|---|---|---|
| Heat | acceptable | acceptable | acceptable | acceptable | acceptable | acceptable | acceptable |
| Resistance | | | | | | | |
| Etching Rate | 1.5 | 1.7 | 1.8 | 1.4 | 1.5 | 1.4 | 1.2 |
| (μm/min) | | | | | | | |
| Coefficient of | 16 | 17 | 17 | 17 | 15 | 16 | 16 |
| Humidity | | | | | | | |
| Expansion | | | | | | | |
| (ppm/% RH) | | | | | | | |
| Peel Strength | 1.3 | 1.1 | 1.1 | 1.3 | 1.4 | 1.2 | 1 |
| after Heating | | | | | | | |
| (kN/m) | | | | | | | |

When the polyimide metal laminates in Examples 1 to 3 were processed into suspensions for hard disks, the suspensions in which the etching rate of polyimide was fast and the processing shape was also good were obtained so that highly productive and high quality suspensions could be prepared.

### Comparative Example 1

<Preparation and Evaluation of a Polyimide Metal Laminate>

Polyimide metal laminates H′ to K′ were prepared and evaluated in the same manner as in Example 1, except that thermoplastic polyimide precursors H to K prepared in Synthesis Example 2 were used as a thermoplastic polyimide. The results are shown in Table 6.

TABLE 6

| | H' | I' | J' | K' |
|---|---|---|---|---|
| Heat | unacceptable | unacceptable | acceptable | acceptable |
| Resistance | | | | |
| Etching Rate | 1.6 | 1.4 | 0.5 | 1.4 |
| (μm/min) | | | | |
| Coefficient of | 18 | 16 | 16 | 25 |
| Humidity | | | | |
| Expansion | | | | |
| (ppm/% RH) | | | | |
| Peel Strength | 0.5 | 0.60 | 0.8 | 0.3 |
| after Heating | | | | |
| (kN/m) | | | | |

### Comparative Example 2

<Preparation and Evaluation of a Polyimide Metal Laminate>

Polyimide metal laminates H″ to K″ were prepared and evaluated in the same manner as in Example 2, except that thermoplastic polyimide precursors H to K prepared in Synthesis Example 2 were used as a thermoplastic polyimide. The results are shown in Table 7.

TABLE 7

| | H” | I” | J” | K” |
|---|---|---|---|---|
| Heat | unacceptable | unacceptable | acceptable | acceptable |
| Resistance | | | | |
| Etching Rate | 1.5 | 1.5 | 0.9 | 1.5 |
| (μm/min) | | | | |
| Coefficient of | 13 | 11 | 11 | 21 |
| Humidity | | | | |
| Expansion | | | | |
| (ppm/% RH) | | | | |
| Peel Strength | 0.5 | 0.60 | 0.8 | 0.3 |
| after Heating | | | | |
| (kN/m) | | | | |

### Comparative Example 3

<Preparation and Evaluation of a Polyimide Metal Laminate>

Polyimide metal laminates H′″ to K′″ were prepared and evaluated in the same manner as in Example 3, except that thermoplastic polyimide precursors H to K prepared in Synthesis Example 2 were used as a thermoplastic polyimide. The results are shown in Table 8.

TABLE 8

| | H'” | I'” | J'” | K'” |
|---|---|---|---|---|
| Heat | unacceptable | unacceptable | acceptable | acceptable |
| Resistance | | | | |
| Etching Rate | 1.8 | 1.6 | 0.8 | 1.6 |
| (μm/min) | | | | |
| Coefficient of | 17 | 17 | 17 | 22 |
| Humidity | | | | |
| Expansion | | | | |
| (ppm/% RH) | | | | |
| Peel Strength | 0.5 | 0.60 | 0.8 | 0.3 |
| after Heating | | | | |
| (kN/m) | | | | |

When the polyimide metal laminates in Comparative Examples 1 to 3 were used as suspensions for hard disks, the etching rate of polyimide was slow and the shape of polyimide was also greatly deviated from the set value so that it was not possible to prepare a suspension with a shape required for a suspension.

### INDUSTRIAL APPLICABILITY

The polyimide metal laminate of the present invention can be properly used as a suspension for a hard disk drive since the wet etching property of polyimide and circuit processability of a metal foil are superior, and heat resistance is good.

1. A polyimide metal laminate comprising a copper foil and a stainless steel foil or stainless steel foils formed on both sides of a polyimide resin, wherein the polyimide resin which comes in contact with the stainless steel foil or the copper foil has a heat resistance temperature being not less than 350° C., the coefficient of humidity expansion at 32° C. being from 1 to 20 ppm/% RH, an average value of the etching rate by a 50 wt % aqueous solution of potassium hydroxide at 80° C. being not less than 1.0 μm/min, and the peel strength after heating at 350° C. for 60 minutes being not less than 1.0 kN/m.

2. The polyimide metal laminate according to claim 1, wherein the polyimide resin which comes in contact with the stainless steel foil or the copper foil is a thermoplastic polyimide obtained by reacting a diamine with a tetracarboxylic acid dianhydride, the tetracarboxylic acid dianhydride in use is obtained by combining at least one kind of tetracarboxylic acid dianhydride selected from pyromellitic acid dianhydride, p-phenylene bis(trimellitic acid monoester anhydride), 3,3′,4,4′-ethylene glycol dibenzoate tetracarboxylic acid dianhydride and 2,2-bis(4-hydroxyphenyl)propane-3,3′,4,4′-benzophenone tetracarboxylic acid dianhydride with 3,3′,4,4′-benzophenone tetracarboxylic acid dianhydride, and 3,3′,4,4′-benzophenone tetracarboxylic acid dianhydride is not less than 5 mole % and not more than 50 mole % of the total tetracarboxylic acid dianhydride in use.

3. The polyimide metal laminate according to claim 1, wherein the polyimide resin which comes in contact with the stainless steel foil or the copper foil is a thermoplastic polyimide obtained by reacting a diamine with a tetracarboxylic acid dianhydride and pyromellitic acid dianhydride is not less than 50 mole % of the total tetracarboxylic acid dianhydride in use.

4. The polyimide metal laminate according to claim 1, wherein the polyimide resin which comes in contact with the stainless steel foil or the copper foil is a thermoplastic polyimide obtained by reacting a diamine with a tetracarboxylic acid dianhydride, and comprises at least one kind of diamine selected from 1,3-bis(3-aminophenoxy)benzene, 4,4′-bis(3-aminophenoxy)biphenyl, 3,3′-diaminobenzophenone and 1,3-bis(3-(3-aminophenoxy)phenoxy)benzene as a diamine in use.

5. A suspension for a hard disk drive prepared from the polyimide metal laminate as described in claim 4.

6. A suspension for a hard disk drive prepared from the polyimide metal laminate as described in claim 3.

7. A suspension for a hard disk drive prepared from the polyimide metal laminate as described in claim 2.

8. A suspension for a hard disk drive prepared from the polyimide metal laminate as described in claim 1.
